(19) United States
(12) Patent Application Publication
(10) Pub. No.: US 2004/0041743 A1
(43) Pub. Date: Mar. 4, 2004

(54) Display apparatus and method for distributed modules of light-emitting elements

(75) Inventors: Shou-Hung Welkin Ling, Langley (CA); Chi-Chia Chang, Taipei (TW); Wei-Chih Liao, Taipei (TW); Wanchih Lin, Taipei (TW)

Correspondence Address: BRUCE H. TROXELL, SUITE 1404, 5205 LEESBURG PIKE, FALLS CHURCH, VA, 22041, US

(73) Assignee: Ownway Biotronics Inc.

(21) Appl. No.: 10/273,296

(22) Filed: Oct. 18, 2002

(30) Foreign Application Priority Data
Aug. 30, 2002 (TW) 091119739

(51) Int. Cl. G09G 5/00

(52) U.S. Cl. 345/1.1

(57) ABSTRACT

A display apparatus and a method for distributed modules of light-emitting elements, the display apparatus comprising: a plurality of display modules, each comprising: a plurality of total passive clusters, an active control module and an electrical structure module. The total passive clusters and the active control module are attached onto the tube-shaped electrical structure module on one side or both sides. The electrical structure module comprises an interface for data and power transmission between the total passive clusters, the active control module and the electrical structure module such that a display apparatus for distributed modules of light-emitting elements is formed. Since easy assembly, setup, removal, maintenance, re-use, adjustment in display size, excellent display size/weight ratio and both single-sided and double-sided display can be achieved, the display apparatus is suitable for use in temporary display sites. Identical total passive clusters and active control modules can be attached onto different electrical structure modules for various luminance intensities and pitches to fulfill a full-color display. Furthermore, a roll-up mechanism may also be provided so as to unfold or fold the display.

### BACKGROUND OF THE INVENTION

1. Field of the Invention

The present invention generally relates to a display apparatus and a method for distributed modules of light-emitting elements and, more particularly, to a display apparatus for distributed modules of light-emitting elements with easy assembly, setup, removal, maintenance and re-use as well as adjustable size and aspect ratio and a display method for such an apparatus. The display apparatus possesses excellent display size/weight ratio with single-sided or double-sided display capabilities.

2. Description of the Prior Art The light-emitting diode (to be abbreviated as LED hereinafter) has received considerable attention for such advantages as high brightness, excellent durability, low heat generation, low power consumption, no limitation of display format, low reflectivity against sunlight, suitability for use in fabrication of large-scale displays, etc. and has been widely used such applications as display panels, traffic signs and indoor/outdoor display boards. Furthermore, the prior art dynamic full-color video display board employs LEDs as light-emitting elements.

Even though mass production of full-color LED-based display boards can be achieved by using the disclosures in the prior arts, the cost of high-brightness blue/green LEDs is still high compared to that of red/yellow ones.

As a result, a mere growth rate of 12% is achieved in the global market of LED-based signs/displays (See Table I) as quoted by website AsiaMoney.com.tw (http://www.asiamoney.com.tw/research/report/001226_{—}1_{—}2.htm). Table I—Global Market for LED-based Signs/Displays (Unit: million USD)

| Year | 1999 | 2000 | 2003 |
|---|---|---|---|
| LED-based | 522 | 598 | 843 |
| Signs/Displays | | | |
| Growth rate | — | 14.56% | 12.13% |

Source: PIDA 8/00

The inventors of the present invention have examined and summarized limiting factors of the LED-based industry into two aspects.

1. Module Aspect:

The conventional large-scale display employing LEDs as light-emitting elements typically comprises module cases that contribute a largest percentage of the total system weight. Since display requirements vary in different occasions, a display configuration is usually dedicated for permanent usage at a particular location. Therefore, the number and pitch of LEDs forming a cluster are designed according to individual requirements.

In order to reduce the cost for manufacturing a display, a panel-type unit has been developed. In most cases, various accessories (mechanical in particular) for different displays are not compatible with one another.

As shown in FIG. 1, a conventional cluster 10 comprises a shell 11; a printed circuit board 12 disposed inside the shell 11; a plurality of LED elements 13 disposed on the front side of the shell 11, the pins of the LED element 13 being soldered with the printed circuit board 12; a wiring 14 having a first end connected to a driving circuit (not shown) via a connector 15 and a second end connected to the printed circuit board 12 via an opening (not shown) on the rear side of the shell 11, the joint between the wiring 14 and the printed circuit board 12 being filled with water-proof material such as epoxy and silicon after the wiring 11 is soldered to the printed circuit board 12. Lacking automated production setup, processes for manufacturing clusters are complex. More particularly, the aforementioned soldering and water-proof material filling processes are performed manually. The reliability manual processes provide is relatively poor, adversely affecting the yield of clusters. Moreover, the cost for manufacturing clusters constitutes a large percentage of manufacturing an entire display. Therefore, manual processes often cause poor reliability and high fabrication cost for the cluster and the entire display alike. Personnel are dispatched on the front side and the rear side for installing and attaching the cluster 10, respectively, costing valuable time and labor. Though the panel-type unit can replace a single cluster for fewer processing steps, it is far from perfect when compared with the present invention.

2. Application Aspect:

As described above, the design of a large-scale display board is based on module cases and clusters. The whole structure is considerably heavy and thus suitable for immobile or long-term applications such as professional baseball parks, football stadiums and arenas. For occasional applications in concerts, World Cup and Olympic Games, large-scale displays are in great demand for a certain period of time. The need arises for large-scale display apparatuses with distributed modules of light-emitting elements. Such apparatuses do not exist despite their advantages:

1. Easy assembly, disassembly and maintenance.

2. Flexibility for repeated applications at various locations.

3. Size and aspect ratio versatility.

In view of the above drawbacks, a few improved structures for large-scale displays have been disclosed. Examples are provided below:

(1) U.S. Pat. No. 6,208,073 “Smart light emitting diode cluster and system” filed by Wang et al. provides a cluster, having drive circuits and data processing boards, as an individual pixel for data receiving and transmission. One advantage of the LED cluster system of subject patent is replaceable display elements. The system is suitable for advertising purposes because it is relatively light. However, the structure of the LED cluster system has to be designed individually according to practical cases, and the assembly steps are complicated. For example, a great amount of sequenced circuitry with software enhancement is required such that well-trained staffs accompanied with skilled engineers are necessary so as to complete the system. Even though the display elements employed in the LED cluster system are for general purposes, the cost and skills for assembly are much higher compared to those of the present invention.

(2) In U.S. Pat. No. 6,065,854 “LED modular display system” filed by West et al., the percentage of mechanisms in weight of the system is reduced with the use of a supporting member with triangular cross-section to replace the steel structure. Moreover, the LED modules include inwardly tapered vertical sidewalls and horizontal upper and lower trapezoidal faces such that the display system is advantageous in easy maintenance, and re-setup. However, compared to the present invention, some portions of the LED modular display system are not recyclable.

(3) U.S. Pat. No. 5,900,850 “Portable large-scale image display system” filed by Bailey et al. provides a portable and foldable large-scale image display system having netlike structures disposed on the steel structure. The netlike panels are distributed over a large-scale steel structure so as to function as a display board. After usage, the display system is foldable. Therefore, the portable large-scale image display system is advantageous in high area/weight ratio and easy removal, and it is thus suitable for use in non-permanent occasions. However, the portable display system is inferior to the present invention, as described hereinafter:

a. The netlike panels are not parts of the structure.

b. In spite of flexibility and easy removal, the fabrication as well as maintenance of components such as belts, clips and stitches connected to the panels fixed on the structure frame is troublesome and the assembly processing requires great amount of time and labor, resulting an increased cost.

(4) U.S. Pat. No. 6,237,290 “High-rise building with large scale display device inside transparent glass exterior” filed by Tokimoto et al. discloses a large-scale display disposed inside a transparent glass exterior to comprise a plurality of louver structured modules. Such a large-scale display device does not affect the building's appearance and is free of water permeation. However, the display device is designed individually according to the appearance as well as the structure employed, therefore it is limited compared to the present invention.

(5) U.S. Pat. No. 6,362,801 “Display apparatus” filed by Yuhara et al. discloses a display apparatus disposed on a 3-dimensional curve surface of a flexible net member instead of a conventional heavy steel structure so as to possess high flexibility, easy removal and low-cost setup. However, compared to the present invention, this prior art is disadvantageous in that the location and orientation of the light-emitting elements are not identical and it is thus difficult to maintain precise pitch and luminance. Moreover, this prior art also suffers from complicated circuitry and time-consuming labor.

### SUMMARY OF THE INVENTION

Therefore, it is a primary object of the present invention to provide a display apparatus for distributed modules of light-emitting elements with easy assembly, setup, removal, maintenance and re-use as well as adjustable size and aspect ratio and a display method of such an apparatus. The display apparatus possesses high display size/weight ratio with single-sided or double-sided display and is suitable for use in temporary display sites.

In the display apparatus for distributed modules of light-emitting elements according to the present invention, a plurality of total passive clusters (TP clusters) and an active control module (AC module) are electrically attached onto a tube-shaped electrical structure module (ES module) via clips on the TP clusters and the AC module and grooves on the ES module such that easy assembly, setup, removal, maintenance and re-use can be achieved so as to adjust the display size; therefore, the display apparatus possesses excellent display size/weight ratio with single-sided or double-sided display and is suitable for use in temporary display sites. Identical TP clusters and AC modules can be attached onto different ES modules for various luminance intensities and pitches to fulfill a full-color display. Furthermore, a roll-up mechanism may also be provided so as to unfold or fold the display.

More particularly, it is a primary object of the present invention to provide a display apparatus and a method for distributed modules of light-emitting elements, comprising a plurality of TP clusters and an AC module electrically attached onto a tube-shaped ES module via clips on the TP clusters and the AC module and grooves on the ES module.

It is another object of the present invention to provide a display apparatus and a method for distributed modules of light-emitting elements with easy assembly, setup, removal, maintenance and re-use.

It is still another object of the present invention to provide a display apparatus and a method for distributed modules of light-emitting elements with adjustable size and aspect ratio.

It is still another object of the present invention to provide a display apparatus and a method for distributed modules of light-emitting elements with high display size/weight ratio.

It is still another object of the present invention to provide a display apparatus and a method for distributed modules of light-emitting elements with single-sided or double-sided display.

It is still another object of the present invention to provide a display apparatus and a method for distributed modules of light-emitting elements suitable for use in temporary display sites.

It is still another object of the present invention to provide a display apparatus and a method for distributed modules of light-emitting elements, in which identical TP clusters and AC modules can be attached onto different ES modules for various luminance intensity and pitches to fulfill a full-color display.

It is yet another object of the present invention to provide a display apparatus and a method for distributed modules of light-emitting elements, provided with a roll-up mechanism so as to unfold or fold the display.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a schematic diagram showing a conventional cluster 10 in accordance with the prior art;

FIG. 2 is a schematic diagram showing a display apparatus 20 for distributed modules of light-emitting elements in accordance with the present invention;

FIG. 3A is a flow chart showing data process from a data/address bus to an addressable display module 24 in accordance with the present invention;

FIG. 3B is a schematic diagram showing an addressable display module 24 in accordance with the present invention;

FIG. 4A is an exploded view showing a total passive cluster 241 in accordance with the present invention;

FIG. 4B shows, from left to right, a front view, a side view and a back view of a circuit board 241b in accordance with the present invention;

FIGS. 4C, 4D and 4E are, respectively, a front view, a side view and a back view of a completed total passive cluster 241 in accordance with the present invention;

FIG. 5 is a schematic diagram showing a total passive cluster 241 attached onto an electrical structure module 242 in accordance with the present invention;

FIG. 6 is a cross-sectional view showing an electrical structure module 242 with a plurality of total passive clusters 241 on both sides in accordance with the present invention;

FIGS. 7A, 7B and 7C are, respectively, a top view, a front view and a side view of a matrix-type video display apparatus 30 in accordance with the present invention; and

FIGS. 8A and 8B are, respectively, a front view and a side view of a rolled-up type video display 40 in accordance with the present invention.

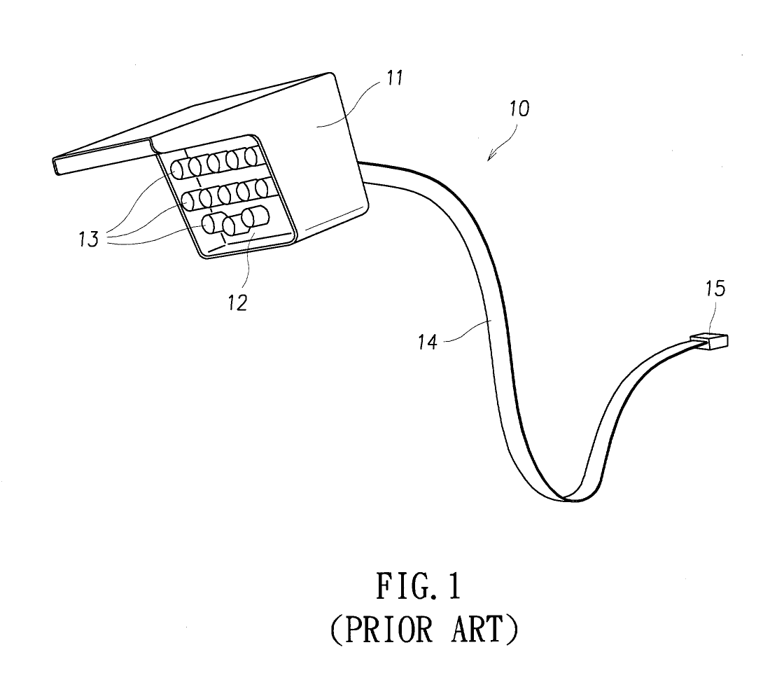

### DETAILED DESCRIPTION OF THE INVENTION

The present invention providing a display apparatus and a method for distributed modules of light-emitting elements can be exemplified by the preferred embodiment as described hereinafter.

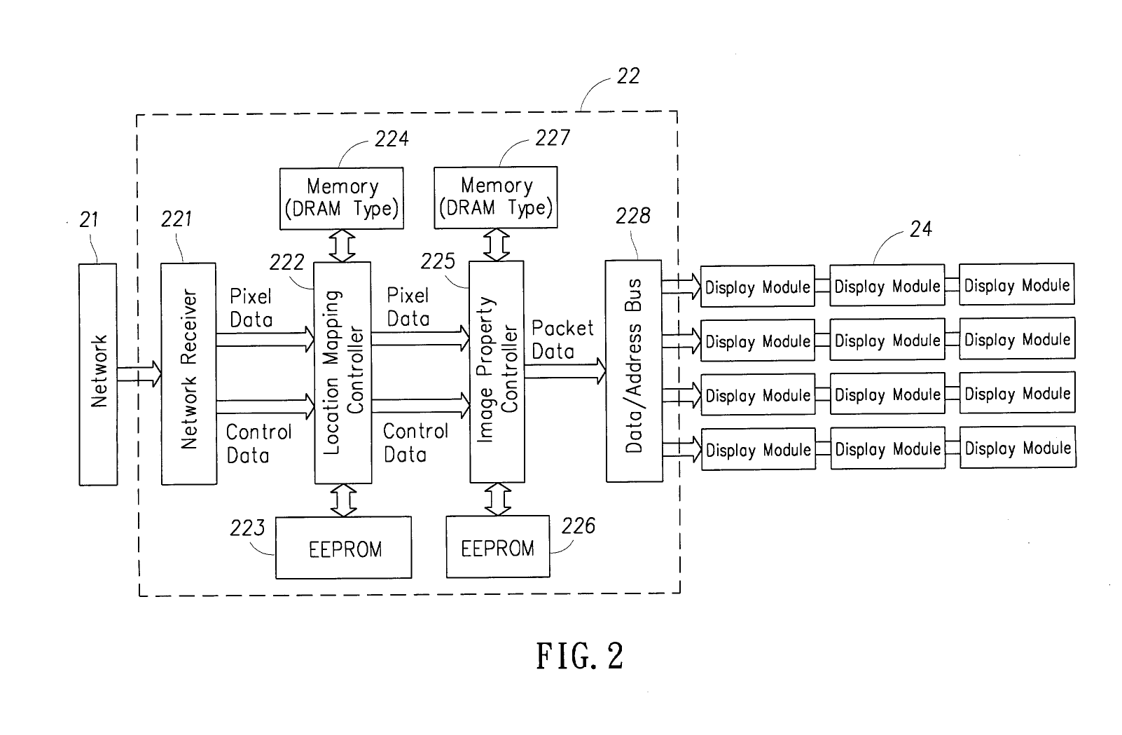

As shown in FIG. 2, the present invention discloses a display apparatus 20 for distributed modules of light-emitting elements comprising a central controller 22 and a plurality of addressable display modules 24 (referred to as “display modules” for short hereinafter). The backside of the central controller 22 is connected with the plurality of addressable display modules 24.

Control data and video data are transmitted to a data receiver 221 of the central controller 22 via a network 21 (for example, Internet or Intranet). The data receiver 221 outputs the control data and pixel data in the video data into a location mapping controller 222 so as to perform location mapping. The location mapping controller 222 is connected to an electrically erasable programmable read-only memory (EEPROM) IC 223 and a memory IC 224. A location mapping table is stored and accessed by the EEPROM IC 223 and a location mapping process is performed with the assistance from the memory IC 224. The pixel data and control data having experienced the location mapping process is then transmitted into an image property controller 225 so as to adjust the image property parameter (such as Gamma value). The image property controller 225 is connected to an EEPROM IC 226 and a memory IC 227. A mapping table is stored and accessed by the EEPROM IC 226 and an image property parameter adjusting process is performed with the assistance from the memory IC 227. A plurality of packet data conforming to pre-determined display conditions and mapped onto respective AC modules are transmitted from the central controller 22 through a data/address bus 228 into a plurality of display modules 24 so as to perform the display driving process.

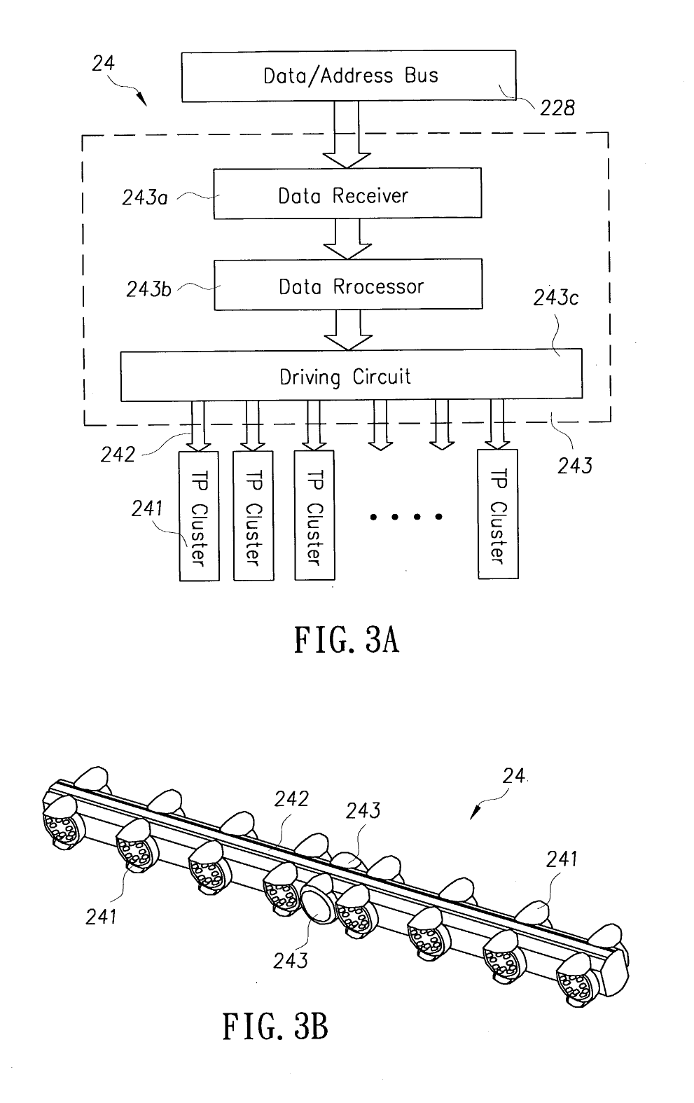

FIG. 3A is a flow chart showing data process from a data/address bus 228 in FIG. 2 to an addressable display module 24, and FIG. 3B is a schematic diagram showing an addressable display module 24. In FIG. 3A and FIG. 3B, a display module 24 comprises a plurality of total passive (TP) clusters 241; an electrical structure (ES) module 242; and an active control (AC) module 243. As shown in FIG. 3A, the AC module 243 comprises a data receiver 243a, a data processor 243b and a driving circuit 243c. A packet data transmitted from the data/address bus 228 and mapped onto the AC module 243 is input into the data processor 243b through a wiring (not shown) of the ES module 242 and the data receiver 243a to experience data processing. The data having experienced data processing is then input into the driving circuit 243c so as to drive the plurality of total passive (TP) clusters 241. Each of the plurality of TP clusters 241 is a light-emitting unit composed of a plurality of light-emitting elements (abbreviated as LEE's) such as light-emitting diodes (abbreviated as LEDs), organic light-emitting diodes (abbreviated as OLEDs) or other light-emitting devices. The plurality of TP clusters 241 are driven by the driving circuit 243c and simultaneously emit light according to the processed data. Therefore, the TP clusters 241 and the ES module 242 are passive module. More particularly, the AC module 243 is used for processing the data and driving the passive LEE's in the TP clusters 241, while the ES module 242 is used for constructing the structure and serves as an interface both structurally and electrically. The AC module 243 is connected to the ES module 242 through the data/address bus 228 so as to receive the corresponding video and control data. The video and control data having experienced data processing controls the driving circuit 243c and then drives the TP clusters 241 through the ES module 242 so as to emit light and display video.

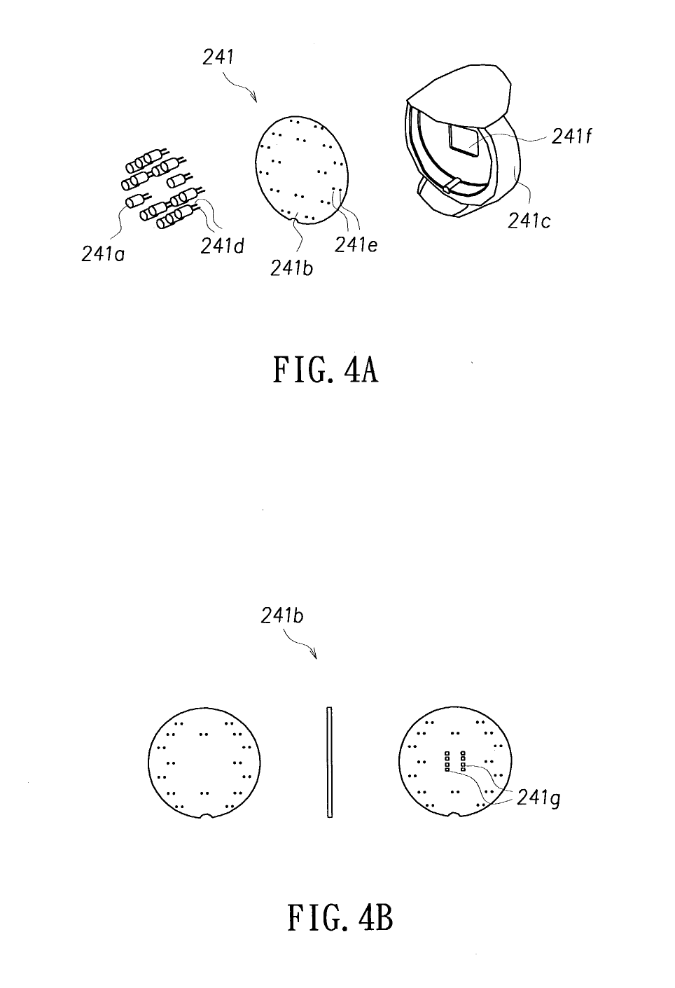

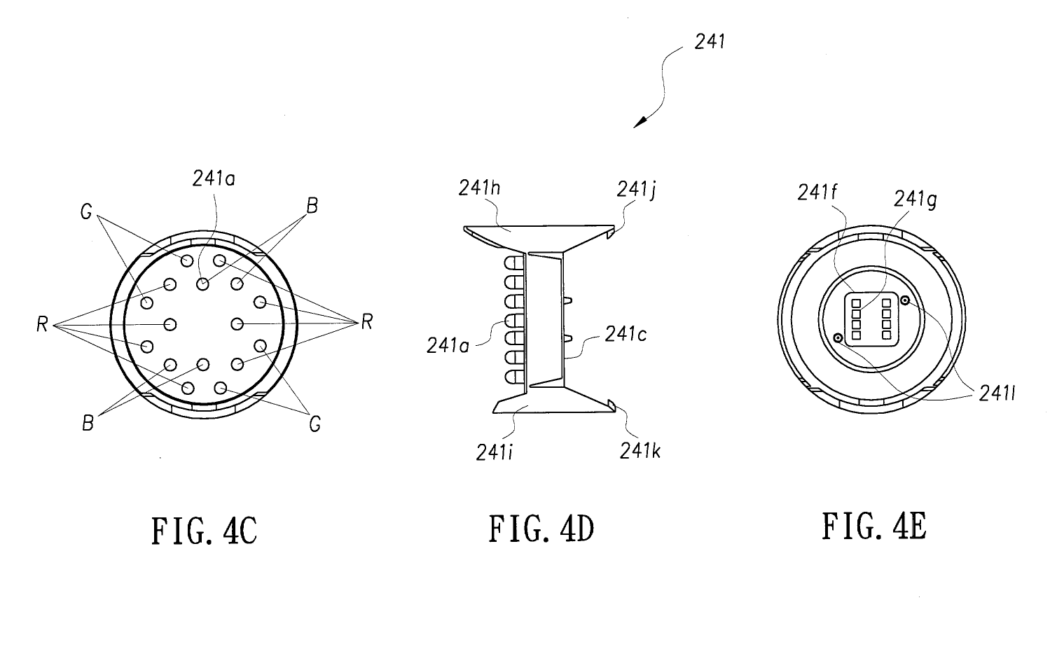

FIG. 4A is an exploded view showing a total passive cluster 241 in accordance with the present invention. In FIG. 4A, the total passive cluster 241 comprises sixteen LEE's 241a, a printed circuit board 241b and a shell 241c formed by plastic injection. The pins 241d of the sixteen LEE's 241a are connected to corresponding contacts 241e on the printed circuit board (referred to as “circuit board” for short hereinafter) 241b. On the shell 241c is formed a window 24f.

FIG. 4B shows, from left to right, a front view, a side view and a back view of a circuit board 241b in accordance with one preferred embodiment of the present invention. The circuit board 241b is installed inside the shell 241c, at the center on the backside of which are disposed eight contacts 241g exposed in the window 241f of the shell 241c. FIGS. 4C, 4D and 4E are, respectively, a front view, a side view and a back view of a completed total passive cluster 241. In FIG. 4C, there are eight R's, four G's and four B's, representing eight red LEE's, four green LEE's and four blue LEE's, respectively, to form a TP cluster 241 composed of sixteen LEE's 241a. In FIG. 4D, there are shown a plurality of LEE's 241a on the left, an upper lid 241h at the top and a lower lid 241i at the bottom. On the upper lid 241h and the lower lid 241i, there are disposed an upper clip 241j and a lower clip 241k, respectively. In FIG. 4E, there are disposed two locating pins 241l for connecting and locating the ES module 242. Exposed in the window 241f at the center of FIG. 4E are eight contacts 241g on the backside of the circuit board 241b.

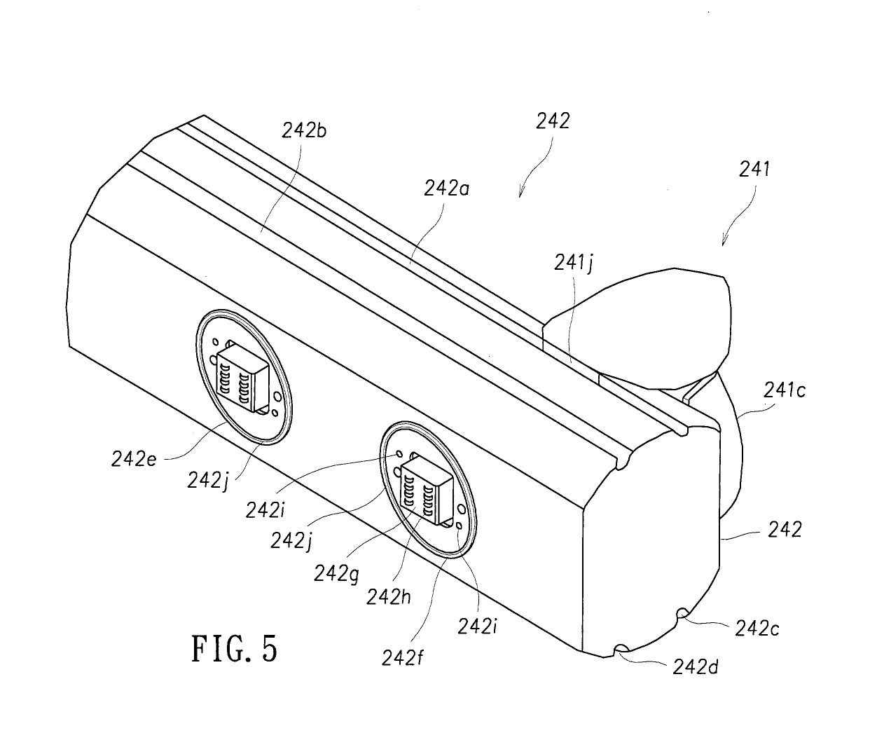

FIG. 5 is a schematic diagram showing a TP cluster 241 attached onto a portion of the ES module 242. On the top of the ES module 242 are disposed a first groove 242a and a second groove 242b, while at the bottom of the ES module 242 are disposed a third groove 242c and a fourth groove 242d. On both sides of the ES module 242 are provided a plurality of connecting devices. On one side, a first connecting device 242e and a second connecting device 242f have the same structure. The second connecting device 242f, for example, comprises two locating holes 242i, a water-proof gasket 242j and a connector 242g, on which there are disposed eight protruding contact springs 242h. When each of the two locating holes 242i corresponds to one of the two locating pins 241l, the compatibility between the shell 241c and the ES module 242 enables the lower lid 241i of the shell 241c to be attached onto the first groove 242a of the ES module 242 and the lower clip 241k to be attached onto the third groove 242c (not shown in FIG. 5) such that the eight contact springs 242h on the ES module 242 electrically connect the eight contacts 241g on the corresponding TP cluster 241. Since the water-proof gasket 242j tightly contacts the TP cluster 241 such that the eight contacts are prevented form the rain and moisture.

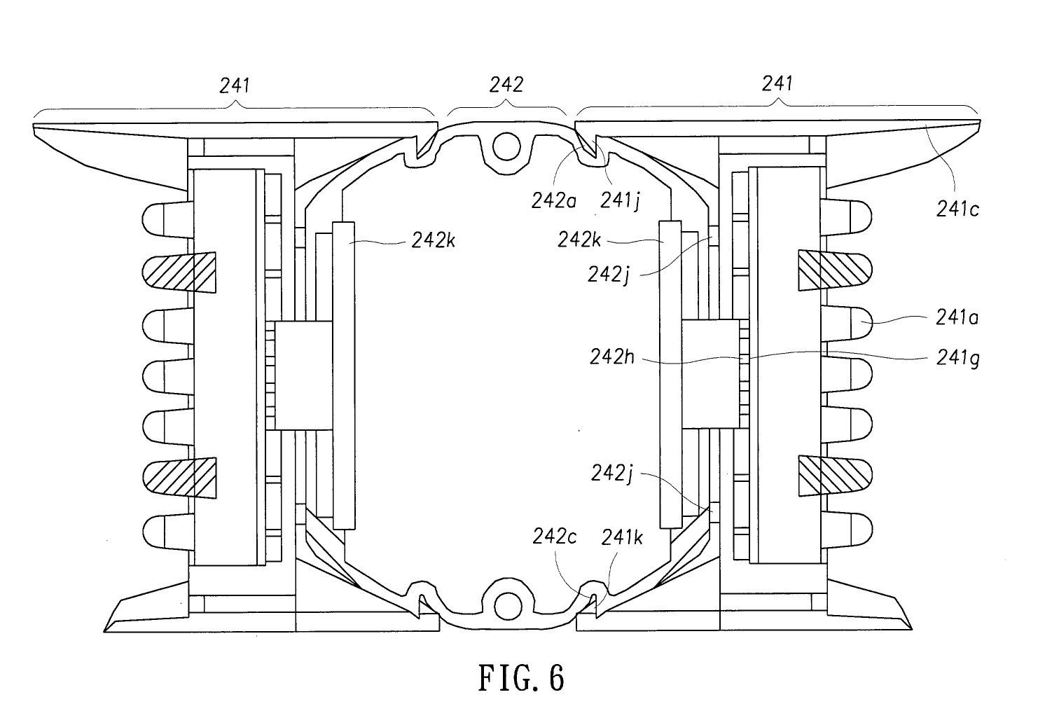

FIG. 6 is a cross-sectional view showing the ES module 242 provided with a plurality of TP clusters 241 on both sides in accordance with the present invention. The interconnection mechanism between the ES module 242 and the TP clusters 241 has been described according to FIG. 5, and thus is omitted hereinafter. Located around the center portion of FIG. 6 is an ES module 242, comprising a cannular aluminum-extruded tube structure for single-sided or double-sided display according to practical cases. When a double-sided display board is concerned, data transmission interface is composed of two circuit boards 242k and associated connectors (not shown) disposed in the cannular portion inside the ES module 242 along the tube-extending direction. Both the power and the data on the bus are transmitted through the components on circuit boards 242k to the AC module (not shown in FIG. 6). The TP clusters 241 are activated by the AC module via the components such that the plurality of LEE's 241a emit light. In FIG. 6, it is clear that the lower lid 241i of the shell 241c is attached onto the first groove 242a of the ES module 242 and the lower clip 241k is attached onto the third groove 242c such that the contact springs 242h on the ES module 242 electrically connect the contacts 241g on the corresponding TP cluster 241. Since the water-proof gasket 242j tightly contacts the ES structure 242 and the TP cluster 241 such that the contacts are prevented form the rain and moisture.

The pitch angle (i.e., the angle relative to the horizontal level) of a TP cluster preferably embodied as 6° can be easily achieved during structural installation. An aluminum-extruded ES module is advantageous that the number and pitch of TP clusters can be easily changed according to practical cases. Different ES modules provide with different pitches so as to meet the requirements in different occasions. The TP clusters and the ES module can be embodied as standard products for easy assembly and re-use. Therefore, the user does not have to re-design the whole system when different requirements are concerned.

The interconnection mechanism between the AC module and the ES module is basically the same as that between the ES module 242 and the TP clusters 241 except that the number of contacts is not necessarily identical. In the display apparatus for distributed modules of light-emitting elements according to the present invention, the operation of all the components for data processing and driving is performed in the AC module, in which the control and video data are obtained by the ES module and then the control and video data having experienced data processing drive the TP clusters via the ES module. Such a design reduces the difficulties for assembly and maintenance and no staff skilled in the system structure is necessary. When a routine maintenance is performed, only the AC module or the TP cluster(s) is required to be updated. Furthermore, when the hardware or the firmware of the AC module is updated or upgraded, only the AC module is required to be changed so as to improve the display apparatus for distributed modules of light-emitting elements according to the present invention.

The most important merit of the display apparatus for distributed modules of light-emitting elements is that all the disclosed components (including elements and modules) can be re-used. Compared to the conventional LED-based display board in the prior arts, the present invention is advantageous in that:

1. It is less difficult in assembling.

2. All the components can be re-used.

3. Easy maintenance can be achieved in the front and all the components can be easily updated, resulting in low maintenance cost.

4. Only minor amendment is required for the ES module so as to meet different requirements without re-designing the whole system.

5. It possesses higher size/weight ratio and less weight than other display boards with the same size.

6. When a single-sided display board is concerned, only the ES module has to be rotated to a position that conforms to the preferable pitch angle; when a double-sided display board is concerned, only the aluminum-extruded shape of the ES module has to be changed so as to meet the preferable pitch angle.

7. The components are simple and distributed to allow excellent heat dissipation such that a forcing convection-type heat-dissipating device is not required.

8. An arc-shaped display board can be easily implemented according to an arc-shaped building.

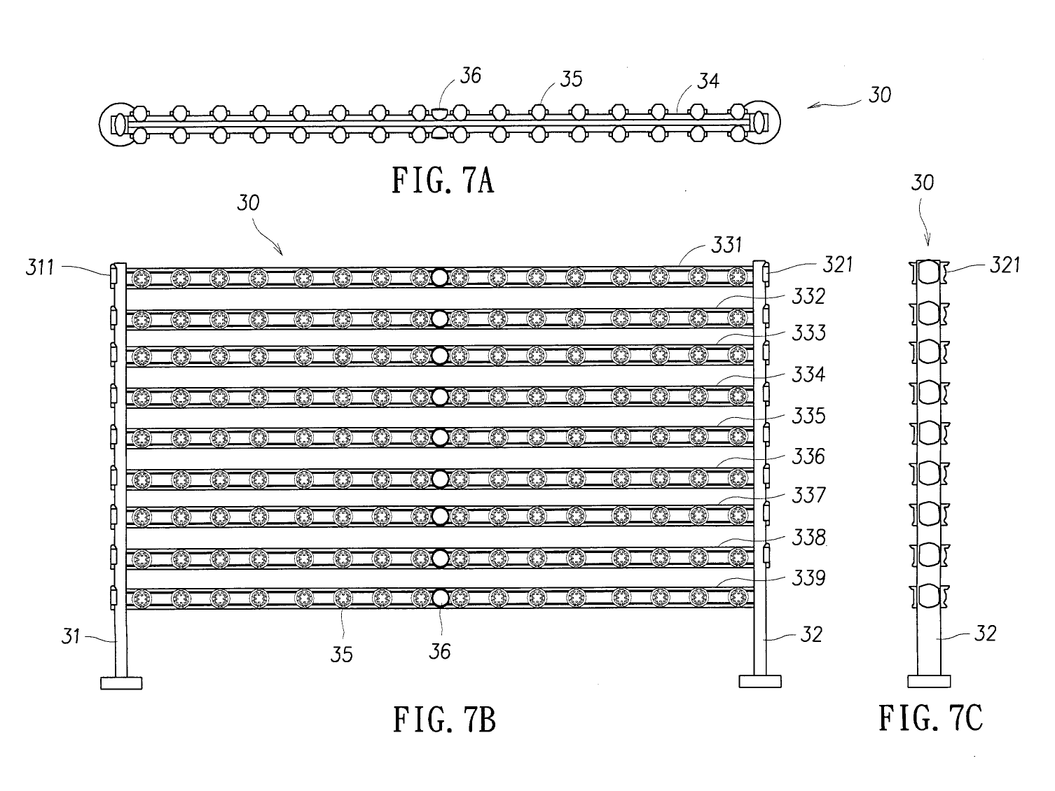

FIGS. 7A, 7B and 7C are, respectively, a top view, a front view and a side view of a matrix-type video display apparatus for distributed modules of light-emitting elements 30 (referred to as “matrix-type video display apparatus” for short hereinafter) in accordance with the present invention. In FIGS. 7A, 7B and 7C, on both sides of a first holder 31 and a second holder 32 are disposed eighteen sockets 311 and 321 (nine on each side, respectively). Nine display modules from the first to the ninth 331 to 339 are composed of an ES module 34, sixteen (for single-sided display) or thirty-two (for double-sided display) TP clusters and an AC module 36, respectively, in the same manner as aforementioned. Two tenons (not shown) on both ends of each of the display modules 331 to 339 are disposed so as to have the display modules 331 to 339 plugged into the corresponding sockets 311 and 321 such that a matrix-type video display apparatus for distributed modules of light-emitting elements 30 is formed. Moreover, a third holder and a fourth holder (not shown) can be disposed on the left of the first holder 31 and the right of the second holder 32, respectively. Nine display modules can be installed between the first holder 31 and the third holder, and nine display modules can also be installed between the second holder 32 and the fourth holder. Therefore, the matrix-type video display apparatus 30 of the present invention can be lengthen or shorten horizontally. Similarly, all of the first holder 31, the second holder 32, the third holder and the fourth holder can be lengthen or shorten. Accordingly, the matrix-type video display apparatus 30 of the present invention can be lengthen or shorten vertically. In other words, the display size and the size/weight ratio of the matrix-type video display apparatus 30 of the present invention can be adjusted at will. Furthermore, the pitch of neighboring TP clusters and the pitch of neighboring sockets 311 and 321 on the first holder and the second holder, respectively, can be easily adjusted too, so as to meet the requirements of various displays. In addition, there are various standard TP clusters to be chosen from for different display purposes.

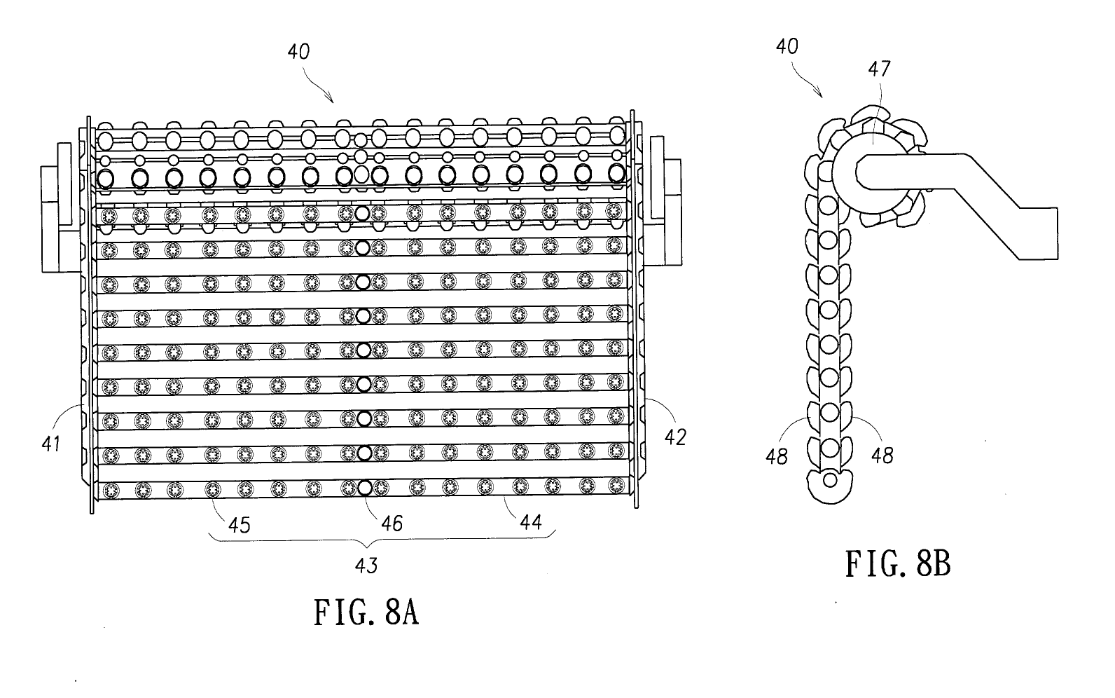

FIGS. 8A and 8B are, respectively, a front view and a side view of a rolled-up type video display 40 for distributed modules of light-emitting elements (referred to as “rolled-up type video display” for short hereinafter) in accordance with the present invention. In FIGS. 8A and 8B, each of the display modules 43 comprising an ES module 44, sixteen TP clusters 45 and an AC module 46 is similar to the display modules 331 to 339 of the matrix-type video display apparatus. The rolled-up type video display 40 differs from the matrix-type video display apparatus 30 in that both ends of the display module are connected to a first chain 41 and a second chain 42, respectively. The topmost display module 43 or the top portions of the first chain 41 and the second chain 42 can be connected to a rotor 47 fixedly disposed via a holder onto an object such as a building. When in operation, the rotor 47 unfolds the display modules 43 in turn so as to display. On the contrary, when not in operation, the rotor 47 rotates in a reversed direction so as to fold the display modules 43 in turn. Moreover, the rotor 47 and the display modules 43 can be removed from the object and re-combined for another occasion. Furthermore, the rolled-up type video display 40 has all the advantages that the matrix-type video display apparatus 30 has. In addition, as shown in FIG. 8B, on both sides of the first chain 41 and the second chain 42 are provided with a plurality of structural holders 48 such that the TP clusters 45 and the AC module 46 are prevented being damaged from when the rotor 47 rotates.

Although this invention has been disclosed and illustrated with reference to a particular embodiment, the principles involved are susceptible for use in numerous other embodiments that will be apparent to persons skilled in the art. This invention is, therefore, to be limited only as indicated by the scope of the appended claims.

What is claimed is:

1. A display apparatus for distributed modules of light-emitting elements, comprising a plurality of display modules, each comprising:
a plurality of total passive clusters, each having a geometric figure comprising: a shell; a light-emitting unit including at least one light-emitting element; and a contact unit including at least one electrical contact electrically connected to the light-emitting unit;
an active control module having a geometric figure comprising: a contact unit; a data receiver connected to the contact unit; a data processor connected to the data receiver; and a driving circuit connected to the data processor; and
an electrical structure module comprising: a linear structural body, on one side of which are provided with a plurality of geometric figures corresponding to the geometric figures of the plurality of total passive clusters and the geometric figure of the active control module, and a plurality of contact units corresponding to the contact units of the plurality of total passive clusters and the contact unit of the active control module, such that the plurality of total passive clusters and the active control module are attached onto the electrical structure module via clips on the total passive clusters and grooves on the electrical structure module; and an interface for data and power transmission between the electrical structure module, the active control module and the plurality of total passive clusters; wherein the plurality of total passive clusters and the active control module are connected to one side of the linear structural body, and the contact units of the plurality of total passive clusters and the contact unit of the active control module are connected to the corresponding contact units of the electrical structure module;
wherein the data receiver is electrically connected to the electrical structure module via the active control module, data mapped onto the active control module is obtained through the interface for data and power transmission, the data is input into the data processor for data processing and then is input into the driving circuit so that the data is electrically connected to the electrical structure module and the plurality of total passive clusters via the interface for data and power transmission so as to drive the light-emitting units in the plurality of total passive clusters to emit light.

2. The display apparatus for distributed modules of light-emitting elements as recited in claim 1, wherein the geometric figure of the total passive clusters is a clip and the geometric figure of the electrical structure module is a groove.

3. The display apparatus for distributed modules of light-emitting elements as recited in claim 1, wherein the plurality of total passive clusters comprise different light-emitting units and identical contact units.

4. The display apparatus for distributed modules of light-emitting elements as recited in claim 1, wherein the corresponding geometric figures combine via clips and groove as a buckle-up member.

5. The display apparatus for distributed modules of light-emitting elements as recited in claim 1, wherein the plurality of total passive clusters further comprises at least one water-proof lid.

6. The display apparatus for distributed modules of light-emitting elements as recited in claim 1, further comprising water-proof materials such as epoxy and silicone filled around the contacts of light-emitting units.

7. The display apparatus for distributed modules of light-emitting elements as recited in claim 1, wherein the linear structural body of the electrical structure module and the shells of the total passive clusters are aluminum-extruded structure.

8. The display apparatus for distributed modules of light-emitting elements as recited in claim 1, further comprising two holders, attached onto the plurality of total passive clusters and the active control module via the clips on the total passive clusters and the grooves on the electrical structure module such that a plurality of electrical structure modules electrically connected are disposed between the two holders.

9. The display apparatus for distributed modules of light-emitting elements as recited in claim 8, wherein the pitch of two neighboring electrical structure modules is pre-determined so as to facilitate gas flow that carries heat away and to reduce the drag of the wind.

10. The display apparatus for distributed modules of light-emitting elements as recited in claim 1, wherein on another side of the structural body are disposed geometric figures and a contact unit identical to those on the one side so as to be attached onto the plurality of total passive clusters and the active control module for electrical connection to provide double-sided display.

11. The display apparatus for distributed modules of light-emitting elements as recited in claim 1, wherein the geometric figure of the active control module is a clip and the geometric figure of the corresponding electrical structure module is a groove.

12. The display apparatus for distributed modules of light-emitting elements as recited in claim 1, wherein the active control module is independently removable, convenient to be maintained, and easy to be updated.

13. The display apparatus for distributed modules of light-emitting elements as recited in claim 1, wherein the same total passive clusters are employed with different electrical modules so as to achieve a full-color display by controlling the luminance intensity and pitch.

14. The display apparatus for distributed modules of light-emitting elements as recited in claim 1, wherein the electrical structure module is tube-shaped and is foldable and unfoldable by using a rotor.

15. A display method for distributed modules of light-emitting elements, comprising steps of:
attaching a plurality of total passive clusters having a light-emitting units onto an electrical structure module having a structural body and an interface for data and power transmission via clips on the total passive clusters and groove on the electrical structure module for electrical connection;
attaching an active control module having a data receiver, a data processor and a driving circuit onto the electrical structure module via the clips on the passive clusters and the groove on the electrical structure module for electrical connection, wherein the data receiver is connected to the data processor, the data processor is connected to the driving circuit, the interface is for data and power transmission between the electrical structure module, the active control module and the plurality of total passive clusters, the plurality of total passive clusters and the active control module are connected to one side of the linear structural body; and
electrically connecting the active control module and the electrical structure module, such that the data receiver obtains data mapped onto the active control module through the interface for data and power transmission; and
inputting the data into the data processor for data processing and then inputting the data into the driving circuit so that the data is electrically connected to the electrical structure module and the plurality of total passive clusters via the interface for data and power transmission so as to drive the light-emitting units in the plurality of total passive clusters to emit light.
